(19) United States
(12) Patent Application Publication
(10) Pub. No.: US 2012/0163807 A1
(43) Pub. Date: Jun. 28, 2012

(54) REPRESENTATION OF THE PHYSICAL DEGRADATIONS IN AN OPTICAL COMMUNICATION NETWORK

(76) Inventors: Annalisa Morea, Nozay (FR); Florence Leplingard, Velizy (FR)

(21) Appl. No.: 13/390,742

(22) PCT Filed: Aug. 12, 2010
(86) PCT No.: PCT/FR2010/051701

§ 371 Date: Mar. 12, 2012

(30) Foreign Application Priority Data
Aug. 24, 2009 (FR) 0955752

(51) Int. Cl. H04B 10/08

(52) U.S. Cl. 398/29; 398/28

(57) ABSTRACT

To produce a representation of the physical degradation in an optical communication network comprising transparent switching nodes (1, 2, 3, 4) mutually connected by optical links (11, 12, 21, 22, 31, 32, 41, 42), the method involves:
Associating a pair of counter-directional optical links as a bi-directional link (10, 20, 30, 40),
Providing at least one respective physical degradation parameter for each of said counter-directional optical links of said pair,
Determining at least one physical degradation parameter characteristic of said bi-directional link from said physical degradation parameters of the counter-directional optical links of said pair,
Storing a descriptor of the bi-directional link comprising said at least one physical degradation parameter characteristic of said bi-directional link.

The invention pertains to the field of optical communication networks, in particular the field of optical networks, which are capable of establishing transparent optical connections to transport data flows.

Establishing a transparent connection in a transparent or hybrid optical network typically involves several operations that can be carried out simultaneously or successively, including the selection of a spatial connection path in the network, the selection of one or more carrier waves available to carry the data on this connection path, and the estimation of the transmission quality attainable with the selected connection path and carrier waves.

FR-A-2864386 describes a method for creating a representation of the physical degradation of unidirectional links in an optical communication network and a method for determining transmission quality, for example in the form of the binary error rate, for a transparent unidirectional optical connection using this representation.

According to one embodiment, the invention describes a method that produces a representation of the physical degradation in an optical communication network comprising transparent switching nodes mutually connected by optical links, said method involving:

Associating a pair of contra-directional optical links as a bi-directional link,
Providing at least one respective physical degradation parameter for each of said contra-directional optical links of said pair,
Determining at least one physical degradation parameter characteristic of said bi-directional link from one of the physical degradation parameters of the contra-directional optical links of said pair,
Storing a descriptor of the bi-directional link comprising said at least one physical degradation parameter characteristic of said bi-directional link.

In other advantageous embodiments, the method may exhibit one or more of the following characteristics:

The physical degradation parameter or parameters characteristic of the bi-directional link include a residual chromatic dispersion parameter, said residual chromatic dispersion parameter being obtained as the mathematical average of the residual chromatic dispersion parameters for each of said contra-directional optical links of said pair.

The physical degradation parameter or parameters characteristic of the bi-directional link include an optical signal to noise ratio parameter, said optical signal to noise ratio parameter being obtained as the smallest value of the optical signal to noise ratio parameters for each of said contra-directional optical links in said pair.

The physical degradation parameter or parameters characteristic of the bi-directional link include a non-linear phase parameter, said non-linear phase parameter being obtained as the largest value of the non-linear phase parameters for each of said contra-directional optical links of said pair.

The physical degradation parameter or parameters characteristic of the bi-directional link include a polarisation mode dispersion parameter, said polarisation mode dispersion parameter being obtained as the root-mean-square value of the polarisation mode dispersion parameters for each of said contra-directional optical links of said pair.

The method comprises a step for diffusing the bi-directional link descriptor in a protocol routing message sent to one or more of the nodes in the optical communication network.

In one embodiment, the invention also provides a database of links for an optical communication network comprising transparent switching nodes mutually connected by optical links, at least two of said optical links being contra-directional and being paired as bi-directional links, said database comprising a descriptor of said bi-directional link, said bi-directional link descriptor comprising at least one physical degradation parameter characteristic of said bi-directional link, said physical degradation parameter being obtained from the physical degradation parameters corresponding to each of said contra-directional optical links of said pair.

A database of this type may be installed in a network node control unit, or in a separate apparatus, for example, a network control apparatus or a path calculation apparatus. It may comprise the bi-directional link descriptors for a more or less large part of the network, depending upon whether the diffusion of these descriptors is implemented, for example through the routing protocol, or on the contrary, if the physical degradation information is stored locally.

According to one embodiment, the invention also provides a method for determining the transmission quality of a transparent optical connection, said connection being designed to bi-directionally link at least two optical transmitter-receiver devices over a connection path in an optical communication network, said method comprising steps consisting of:

Providing a bi-directional link descriptor for each of a set of bi-directional links along said connection path, said bi-directional link descriptor comprising at least one physical degradation parameter characteristic of said bi-directional link, said bi-directional link comprising one pair of contra-directional optical links, said physical degradation parameter being obtained from the physical degradation parameters corresponding to each of the contra-directional optical links of said pair,
Determining said transmission quality of the connection according to said bi-directional link descriptors.

According to the embodiments, the bi-directional link descriptors may be provided by extraction from one or more databases installed in the network node control units or in separate apparatus, for example a network control apparatus or a path calculation apparatus.

According to a preferred embodiment, the physical degradation parameter or parameters characteristic of the bi-directional link comprise one or more accumulated parameters, said method comprising the determination of a value for each cumulative parameter accumulated over said connection path and the determination of the transmission quality in relation to the accumulated value or values over the connection path.

The invention starts from the observation that bi-directional connections are frequently used in optical communication networks. A foundation idea for the invention is to provide a representation of the physical degradation in an optical network at the bi-directional link level to be able to determine transmission quality for a transparent bi-directional optical connection without requiring a decomposition of the bi-directional connection into two contra-directional connections. Another idea underlying the invention is to bundle the physical degradation parameters of the unidirectional optical links comprising a bi-directional link in order to obtain a compact and reliable representation of the physical degradation incurred by the signals on this bi-directional link.

The invention can be better understood, and other purposes, details, characteristics, and advantages thereof will become more readily apparent upon examining the following description of multiple particular embodiments of the invention, which are given only by way of illustrative and non-limiting examples, with reference to the attached drawings. In these drawings:

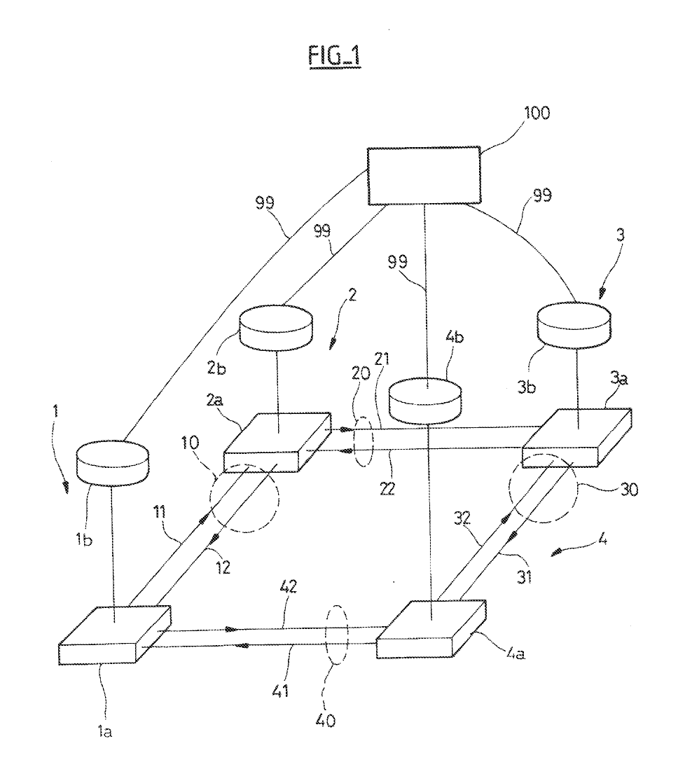

FIG. 1 is a functional schematic depiction of an optical communication network wherein embodiments of the invention may be implemented.

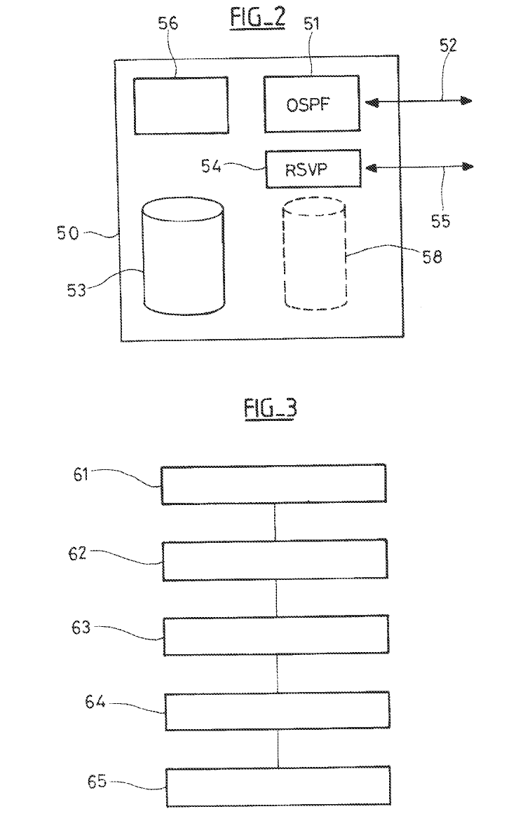

FIG. 2 is a functional schematic depiction of a node control unit that may be used in the nodes on the network in FIG. 1.

FIG. 3 is a diagram of steps of a method for generating bundled link descriptors, which may be implemented in the network in FIG. 1.

FIG. 1 depicts a very simple example of a wavelength division multiplexing (WDM) optical network able to establish transparent connections. The network comprises four transparent communication nodes 1, 2, 3, and 4, connected by unidirectional optical links 11, 12, 21, 22, 31, 32, 41 and 42. Transparent switching node means a device able to switch optical signals without converting them to electronic signals. This term does not exclude a node from also being able to regenerate optical signals by O/E/O conversion if necessary. The term hybrid node is also used to designate a transparent node able to regenerate signals.

FIG. 1 shows a transparent or hybrid optical switching device for each node 1a, 2,a, 3a, or 4a, that is part of the data plan and a control unit 1b, 2b, 3b, or 4b, that is part of the control plan. Separation of the network into the data and control plans is functional. It is shown for didactic purposes but does not necessarily correspond to the concrete structure of the network components.

Many known architectures for optical switching devices are suitable for creating devices 1a to 4a, for example using components such as wavelength multiplexers and demultiplexers, beam splitters and combiners, optical switching matrices, wavelength selection switches, wavelength blockers, optical gates, wavelength converters, etc. Devices 1a to 4a may also comprise electrical-optical conversion interfaces, for example optical transmitters, to insert carrier waves into optical links, and optical-electrical conversion interfaces, for example optical receivers, to demodulate the data carried on the carrier waves.

Unidirectional optical links 11 to 42 comprise optical fibres to transport a multiplex of carrier waves between two neighbouring nodes. These links may also comprise various components not shown, such as optical amplifiers and/or dispersion compensation devices, especially to cover the longest propagation distances.

The network in FIG. 1 shows a very simple ring-shaped topology for the purposes of clarity. However, the following information is not limited to this example and can be applied to a network with any topology having any number of nodes and links.

In one embodiment, the node control unit's 1b to 4b communicate among themselves through control channels to implement the functionalities such as discovery of the topology, route calculation, establishing connections, detecting and recovering from faults, and others. This layout constitutes a distributed control plan for the network, which may be implemented using the GMPLS (Generalized Multi Protocol Label Switching) protocol suite, which is described in particular in the publications of the IETF (Internet Engineering Task Force).

In another embodiment, some of these functionalities are centrally implemented by a central network control apparatus 100 that communicates with each node through links 99 to configure the node, for example according to instructions provided by a human operator.

FIG. 2 functionally depicts a node control unit 50 in an embodiment implementing the GMPLS protocol suite, usable in nodes 1 to 4. A routing module 51 implements a link status routing protocol, for example OSPF-TE or IS-IS-TE, and exchanges routing messages 52 with the other nodes according to this protocol, so as to disseminate topology, connectivity, and capacity information for the network links, according to the established technique. The node control unit 50 comprises a traffic engineering database 53 fed by the routing module 51 and in which this information is stored and dynamically updated.

The node controller 50 comprises a physical database 58 in which the physical parameters of the network links and nodes are stored. The physical database 58 is fed for example by the routing module 51 to dynamically update this information. In one variation, the physical database 58 may be fed from a central network control apparatus. Various types of physical data may be established in the database 58, so as to allow calculation of the predicted degradation of the optical signals over a given transparent path in the network. For example, parameters usable for this purpose are the cumulative chromatic dispersion per link, the OSNR degradation per link, the cumulative non-linear phase per link, the polarisation mode dispersion (PMD) of the link, etc. These parameters being partly dependent upon the wavelength, the values for the worst carrier wave, or average values for the spectrum used in the network, or tables of specific values for respective wavelength intervals may be saved. While the database 58 is shown individually and separately for the purposes of simplicity, it is possible to structure these data in different ways, in particular in the form of several interconnected data structures.

A signalling module 54 implements a signalling protocol, for example RSVP-TE, and exchanges signalling messages 55 with other nodes according to this protocol, so as to manage the connections passing through the node, in particular connection establishment, modification, or deletion operations. The traffic engineering database 53 is updated according to the connections established through the node, under the control of an admission control module 56, so as to dynamically record the resource occupation status.

There are several possibilities for carrying control messages in a GMPLS network, routing messages 52 and signalling messages 55 in particular. For example, these messages may be carried on the same links as the data traffic (“in-fibre”) or on separate dedicated links, on the same channels (“in-band”), or on separate dedicated channels.

To establish a connection over the network in FIG. 1, for example a Lambda LSP (Label-Switched Path) between node 1 and node 4, there are essentially three categories of operations to be implemented: the determination of a spatial path, in other words the determination of the nodes and links that will be used, wavelength assignment, in other words the determination of the channel or channels that will be used on these links, and the consideration of the physical degradation of the optical signal, in other words the determination of the signal quality that can be obtained at the destination. The document, “A Framework for the Control of Wavelength Switched Optical Networks (WSON) with Impairments,” G. Bernstein et al, 5 May 2009, from the IETF describes several possible architectures for implementing these operations, respectively called Routing, Wavelength Assignment, and Impairment Validation.

We will now describe an embodiment of a method able to carry out these operations for a bi-directional connection.

The network topology information, for example as stored in the database 53 of one or more nodes on the network, comprises bi-directional links 10, 20, 30, and 40, respectively connecting nodes 1 and 3, 2 and 3, 3 and 4, and 4 and 1. In each case, a bi-directional link is an association of the two unidirectional links in opposing directions extending between a pair of switching nodes, in other words two contra-directional links. Each bi-directional link 10 to 40 is saved in the database 53 showing its properties. For example, a bi-directional link is saved in the form of a bundled link whose components (component links) comprise the corresponding two contra-directional links. More details on the representation and usage of bundled links in a GMPLS network are given in Request for Comment 4201 from the IETF, October 2005. The representation of the network topology in the form of bundled links, in particular in the form of bi-directional links 10, 20, 30, and 40 can help limit the volume of topology data carried and managed by the network control plan. A route calculation operation may be carried out based on this representation to provide a spatial path in the form of a sequence of bi-directional links, for example the sequence 10-20-30 in the example cited above.

To show the physical degradation of the signals over the connection path, a corresponding bundling process is used. A descriptor of the physical properties of each bi-directional link is stored in the network, for example in the database 58 of one or more nodes or in apparatus 100. These bi-directional link descriptors comprise one or more physical parameters, obtained in each case from the physical parameters corresponding to each of the links thus bundled. A process for determining or predicting the physical transmission quality over the connection path can then be carried out based on the bi-directional link descriptors that constitute this path, to provide a result qualifying both propagation directions together. Such a method thus avoids the need for calculating the physical degradations separately for both connection directions.

Many methods can be envisioned for showing the physical parameters of a bundled link. A compact and reliable representation of the physical degradation incurred by the signals can be obtained using the parameters listed in the following table:

| Physical | | Parameter | |
|---|---|---|---|
| degradation | | calculation | |
| parameter | Parameter | rule for the | Formula for bi-directional |
| notation | name | bundled link | link 10 |
| P1 | Degradation | Minimum | P1(10) = Min[P1(11), |
| | of the optical | value among | P1(12)] |
| | signal to | the | |
| | noise ratio | components | |
| | (OSNR) | of the | |
| | | bundled link | |
| P2 | Polarisation | Root-mean- | P2(10) = √[(P2(11)² + |
| | mode | square value | P2(12)²]/2 |
| | dispersion | of the | |
| | | components | |
| | | of the | |
| | | bundled link | |
| P3 | Residual | Mathematical | P3(10) = [(P3(11) + |
| | chromatic | average | P3(12)]/2 |
| | dispersion | value for the | |
| | | components | |
| | | of the | |
| | | bundled link | |
| P4 | Non-linear | Maximum | P4(10) = Max[P4(11), |
| | phase | value among | P4(12)] |
| | | the | |
| | | components | |
| | | of the | |
| | | bundled link | |

In the table above, the notation pi (k) designates the value of parameter Pi, where i is a whole number from 1 to 4, for link reference k. The fourth column describes the four physical degradation parameters used to comprise a bi-directional link descriptor 10. The other bi-directional links are represented by the respective descriptors obtained in the same way.

In one embodiment, the transmission quality of a future connection is determined by exploiting the bi-directional link descriptors obtained in this way according to the methods described in FR-A-2864386 to exploit the transmission quality vector for a unidirectional link. In other words, for a path comprising a sequence of bi-directional links, the parameters Pi (i being a whole number from 1 to 4) for the respective bi-directional links are composed according to the composition laws listed in FR-A-2864386 to obtain values characterising the bi-directional connection from end to end. An interpolation function then allows the determination of an estimated binary error rate value, valid for both propagation directions, from the physical degradation parameters accumulated over the connection path. Such an exploitation could be integrated in various ways into a method for establishing a connection, in particular according to the various conceptual architectures listed in the aforementioned document “A Framework for the Control of Wavelength Switched Optical Networks (WSON) with Impairments”.

FIG. 3 shows a suitable method for automatically generating bundled link descriptors. This method may be implemented by one or more node control units on the network, or in a centralised control apparatus.

In step 61, the components of a bundled link are determined, for example by querying a traffic engineering database.

In step 62, the physical degradation parameters for each component of the bundled link are provided, for example in the form of one or more configuration files. These data may be entered manually by an operator or determined automatically by an auto-discovery mechanism. The physical degradation parameters comprise for example the four parameters Pi mentioned above for each component of the bundled link.

In step 63, the physical degradation parameters for the bundled link are calculated according to the corresponding parameters for the components of the bundled link, for example according to the formulas cited above.

In step 64, a bundled link descriptor is stored, for example in the form of one or more TLV (Type, Length, Value) data structures, or other structure types.

In step 65, the bundled link descriptor is sent to one or more nodes on the network, for example in the form of a Link State Advertisement message in the OSPF-TE routing protocol. However, this diffusion is only necessary if the bundled link descriptor is exploited by a different apparatus than the one that generated it.

In one embodiment, a centralised network control apparatus collects the descriptors for all links in a network or domain, and centrally determines the transmission quality for connections over this network or domain. In another embodiment, the transmission quality of a connection is determined in a distributed fashion by the node control units located on the connection path. In such a case it may be sufficient for each node to know only the descriptors for the links adjacent to it.

The method in FIG. 3 may be applied to any bundled link, in particular to bundled links comprising components in two opposing directions, which is to say a bi-directional link, or a bundled unidirectional link. There may be any number of components.

Some of the elements depicted, particularly the command units, servers, and other modules, may be constructed in various forms, in a stand-alone or distributed fashion, using hardware and/or software components. Hardware components that may be used are application-specific integrated circuits, field-programmable gate arrays, or microprocessors. Software components may be written in various programming languages, such as C, C++, Java, or VHDL. This list is not exhaustive.

A network management device may be a hardware device, such as a microcomputer, a workstation, a device connected to the Internet, or any other dedicated or general-purpose communication device. Software programs run by this system fulfil network management functions for controlling network elements.

Although the invention has been described in connection with multiple specific embodiments, it is naturally not in any way limited to them, and comprises all technical equivalents of the means described, as well as their combinations, if said combinations fall within the scope of the invention.

The use of the verb “comprise” or “include” and their conjugated forms does not exclude the presence of elements or steps other than those set forth in a claim. The use of the indefinite article “a” or “an” for an element or step does not, unless otherwise stated, excluded the presence of a plurality of such elements or steps. Multiple means or modules may be depicted by a single hardware element.

In the claims, any reference sign within parentheses should not be interpreted as limiting the claim.

1. Method for producing a representation of physical degradations in an optical communication network comprising transparent switching nodes (1, 2, 3, 4) mutually connected by optical links (11, 12, 21, 22, 31, 32, 41, 42), said method comprising:
associating a pair of counter-directional optical links as a bi-directional link (10, 20, 30, 40),
providing at least one respective physical degradation parameter for each of said counter-directional optical links of said pair,
determining at least one physical degradation parameter characteristic of said bi-directional link from said physical degradation parameters of the counter-directional optical links of said pair,
storing a descriptor of the bi-directional link comprising said at least one physical degradation parameter characteristic of said bi-directional link.

2. Method according to claim 1, characterised by the fact that at least one of said physical degradation parameters characteristic of said bi-directional link includes a residual chromatic dispersion parameter, said residual chromatic dispersion parameter being obtained as the mathematical average of the residual chromatic dispersion parameters for each of said counter-directional optical links of said pair.

3. Method according to claim 1, characterised by the fact that at least one of said physical degradation parameters characteristic of said bi-directional link includes an optical signal to noise ratio parameter, said optical signal to noise ratio parameter being obtained as the smallest of the optical signal to noise ratio parameters for each of said counter-directional optical links of said pair.

4. Method according to claim 1, characterised by the fact that at least one of said physical degradation parameters characteristic of said bi-directional link includes a non-linear phase parameter, said non-linear phase parameter being obtained as the largest of the non-linear phase parameters for each of said counter-directional optical links of said pair.

5. Method according to claim 1, characterised by the fact that at least one of said physical degradation parameters characteristic of said bi-directional link includes a polarisation mode dispersion parameter, said polarisation mode dispersion parameter being obtained as the root-mean-square value of the polarisation mode dispersion parameters for each of said counter-directional optical links of said pair.

6. Method according to claim 1, comprising a step for diffusing the bi-directional link descriptor in a protocol routing message sent to one or more of the nodes in the optical communication network.

7. Database of links (58) for an optical communication network comprising transparent switching nodes (1) mutually connected by optical links (11,12), at least two of said optical links being counter-directional and being paired as a bi-directional link (10), said database comprising a descriptor of said bi-directional link, said bi-directional link. descriptor comprising at least one physical degradation parameter characteristic of said bi-directional link, said physical degradation parameter being obtained from the physical degradation parameters corresponding to each of said counter-directional optical links of said pair.

8. Method for determining transmission quality of a transparent optical connection, said connection being intended to bi-directionally link at least two optical transmitter-receiver devices over a connection path in an optical communication network, said method comprising steps consisting of:
providing a bi-directional link descriptor for each of a plurality of bi-directional links (10, 20, 30) along said connection path, said bi-directional link descriptor comprising at each provision, at least one physical degradation parameter characteristic of said bi-directional link, said bi-directional link comprising at each provision a pair of counter-directional optical links, said physical degradation parameter being obtained from physical degradation parameters corresponding to each of the counter-directional optical links of said pair,
determining said transmission quality of the connection according to said bi-directional link descriptors.

9. Method according to claim 8, characterised by the fact that at least one of said physical degradation parameters characteristic of the bi-directional link comprises a cumulative parameter, said method comprising the determination of the value of said cumulative parameter accumulated over said connection path, and the determination of the transmission quality according to said value accumulated over said connection path.
